(19) United States
(12) Patent Application Publication
(10) Pub. No.: US 2005/0280524 A1
(43) Pub. Date: Dec. 22, 2005

(54) Vehicle entertainment and accessory control system

(75) Inventors: David Daniel Boone, Branson, MO (US); William Stone, Springfield, MO (US); Don Johnson, Republic, MO (US); Jeff Brown, Kirbyville, MO (US); William Hagler, Forsyth, MO (US); Daniel Smith, Collbran, CO (US)

Correspondence Address: HOVEY WILLIAMS LLP, 2405 GRAND BLVD., SUITE 400, KANSAS CITY, MO, 64108, US

(73) Assignee: Applied Digital, Inc.

(21) Appl. No.: 10/950,129

(22) Filed: Sep. 24, 2004

Related U.S. Application Data
(63) Continuation-in-part of application No. 10/872,310, filed on Jun. 18, 2004.

(51) Int. Cl. G09F 9/00

(52) U.S. Cl. 340/461

(57) ABSTRACT

A vehicle entertainment and accessory control system (10) is disclosed. The control system (10) provides a plurality of touchscreens (12,14,16) that present user interfaces (38,62) concurrently with video windows (40,64). The user interfaces (38,62) enable users to control various entertainment components, such as a video display (22) and a speaker (24), as well as other vehicle accessories, such as an intercom (28). The entertainment components are controlled via a universal infrared controller (20). A master touchscreen (12) enables a user to control access to the system (10) via a plurality of passenger touchscreens (14,16) by disabling or limiting the use of the passenger touchscreens (14,16).

### RELATED APPLICATIONS

The present application is a continuation-in-part patent application and claims priority benefit, with regard to all common subject matter, of earlier-filed U.S. nonprovisional patent application titled “VEHICLE ENTERTAINMENT AND ACCESSORY CONTROL SYSTEM”, Ser. No. 10/872,310, filed Jun. 18, 2004. The identified earlier-filed application is hereby incorporated by reference into the present application.

### BACKGROUND OF THE INVENTION

1. Field of the Invention

The present invention relates to control systems that enable users to control vehicle entertainment systems and other vehicle accessories via a centralized controller system with distributed user interfaces. More particularly, the present invention relates to a system that is controlled by touchscreens distributed throughout the vehicle, wherein graphical user interfaces and entertainment video are displayed concurrently on each touchscreen.

2. Description of Prior Art

Modern vehicles increasingly include automated accessories, such as power seats, power door locks, and automated climate control systems. Complex entertainment systems that include both audio and video entertainment are also becoming popular in vehicles. Such entertainment systems are most commonly found in luxury vehicles, such as limousines, but are also found in other multi-passenger vehicles, such as vans, sport utility vehicles, and buses.

Traditional vehicle accessory and entertainment systems suffer from several limitations that render them unsuitable to meet the demands of modern automated accessory and entertainment systems. Traditional systems, for example, are designed primarily to serve all or many passengers simultaneously. While some accessories, such as power windows and door locks, are commonly controlled centrally, such as by a driver, and locally, such as by a passenger sitting near the door or window, most accessories and entertainment components are controlled centrally only. Car radios, for example, traditionally serve all vehicle occupants simultaneously through a speaker system, but can only be controlled centrally by the driver or other front seat passenger. Thus, traditional systems are not equipped to provide localized entertainment and accessories.

Another limitation of traditional vehicle accessory and entertainment systems is system control. Passengers are often located throughout a vehicle and cannot move about the vehicle freely, such as in a limousine where the chauffeur is physically separated from the other passengers, or in a passenger van where it may be very difficult for a passenger to safely move about the van. In such situations traditional system controls, which are centralized on a system control panel, are accessible only by a limited number of passengers and render it difficult or impossible for other passengers to control the system. This is incompatible with modern systems that tailor entertainment and accessories to individual vehicle occupants.

Finally, traditional control systems are designed for frequent users who will become familiar with, and remember, the details of the system. Such systems typically require a user to take time to learn all of the details of the system controls, either by trial and error or by reading an instruction manual. This is undesirable for systems intended to serve many different passengers for a short time, such as a rental limousine or a taxicab.

Systems known in the art attempt to address the needs related to modern vehicle accessory and entertainment controls. U.S. Patent Application Publication No. 2003/0004616 A1 (the '616 application), for example, discloses a vehicle accessory control system with a main user interface as well as a center console and a rear console, wherein the main interface and each console includes a touchscreen to give a user control of the system. The main interface is positioned to serve a driver while the center console serves a front seat passenger and the rear console serves a back seat passenger. The center console and the rear console each control vehicle accessories affecting their respective, immediate locations, including separate audio channels and local climate control.

The prior art vehicle accessory control systems suffer from several undesirable limitations. The '616 application, for example, provides only very limited local entertainment options for each passenger as each console provides only local music and not other forms of entertainment, and several passengers are forced to share each console. Furthermore, such systems do not include functions desirable in larger system implementations, such as control of communications between passengers. Finally, the prior art systems require entertainment system components that are uniquely compatible with each system, rendering the components time consuming and/or costly to replace.

Thus, a need exists for a vehicle accessory and control system that provides local audio and other forms of entertainment to each passenger as well as centralized entertainment to all passengers; gives each passenger control over local entertainment and other accessories; and employs controls that are easy to learn and use.

### SUMMARY OF THE INVENTION

The present invention provides an improved vehicle entertainment and accessory control system that does not suffer from the problems and limitations of the prior art described above. Particularly, the present invention provides a system that includes a plurality of touchscreens distributed throughout a vehicle which provide user interfaces that allow each passenger to control entertainment system components and other accessories in his or her immediate area as well as centralized accessories. Each touchscreen selectively displays only the interface, only entertainment video, or both the interface and entertainment video concurrently.

In one embodiment, the invention features a vehicle entertainment and accessory control system. The system includes a touchscreen for concurrently displaying user interface graphics and entertainment video, wherein the touchscreen receives entertainment and accessory control instructions via the interface. The system further comprises a computer processor for controlling the touchscreen, receiving the instructions from the touchscreen, and generating entertainment and accessory control signals in response to the instructions, an infrared controller for generating infrared control signals in response to the entertainment control signals, and an intercom for providing communication between two users in response to the accessory control signals.

In another embodiment, the system includes a plurality of touchscreens distributed throughout a vehicle and accessible by a plurality of users, wherein each touchscreen selectively displays only a user interface, only entertainment video, or both the user interface and the entertainment video concurrently, and wherein the touchscreen receives entertainment and accessory control instructions via the interface. A computer processor controls the touchscreens, receives the instructions from the touchscreens, and generates entertainment and accessory control signals in response to the instructions. An infrared controller generates infrared control signals in response to the entertainment control signals, and an intercom provides communication between two users in response to the accessory control signals. An accessory controller selectively controls a vehicle accessory in response to the accessory control signals.

In another embodiment, the system includes a plurality of touchscreens distributed throughout a vehicle and accessible by a plurality of users, wherein each touchscreen displays a user interface and receives entertainment and accessory control instructions from a user via the interface. Each touchscreen further displays entertainment video in response to the entertainment control instructions and selectively displays only the interface, only the video, or both the interface and the video concurrently. Wherein access to one or more of the touchscreens is selectively disabled via a driver's touchscreen and a lockout feature prevents entertainment video from being displayed on the driver's touchscreen while the vehicle is moving. A computer processor controls the touchscreens, receives the instructions from the touchscreens, and generates entertainment and accessory control signals in response to the instructions. An infrared controller generates infrared control signals in response to the entertainment control signals. A video display displays entertainment video in response to the infrared control signals, a speaker plays audio in response to the infrared control signals, and a media source communicates video and audio signals to the video display and to the speaker in response to the infrared control signals. An intercom provides communication between a driver and a passenger in response to the accessory control signals generated by the processor. A plurality of accessory controllers control vehicle accessories in response to the accessory control signals generated by the processor.

Other aspects and advantages of the present invention will be apparent from the following detailed description of the preferred embodiments and the accompanying drawing figures.

### BRIEF DESCRIPTION OF THE DRAWINGS

A preferred embodiment of the present invention is described in detail below with reference to the attached drawing figures, wherein:

FIG. 1 is a perspective view of a master touchscreen of a vehicle entertainment and accessory control system constructed in accordance with a preferred embodiment of the present invention, wherein the system is implemented in a limousine and the master touchscreen is installed in a steering wheel of the limousine;

FIG. 2 is a perspective view of a plurality of passenger touchscreens and a video display of the system of FIG. 1, wherein the passenger touchscreens and the video display are installed in a passenger compartment of the limousine;

FIG. 3 is a schematic of components of the system of FIG. 1;

FIG. 4 is a depiction of a visual graphic implemented by the master touchscreen of FIG. 1, wherein the graphic includes a user interface portion and a video window portion;

FIG. 5 is a depiction of the visual graphic of FIG. 4, wherein the video window portion has been expanded to occupy the entire master touchscreen;

FIG. 6 is depiction of a visual graphic implemented by a passenger touchscreen of FIG. 2, wherein the graphic includes a user interface portion and a video window portion;

FIG. 7 is a depiction of the visual graphic of FIG. 6, wherein the video window portion has been expanded to occupy the entire passenger touchscreen;

FIG. 8 is a depiction of an entertainment control submenu of the user interface of FIG. 6;

FIG. 9 is a depiction of a video options control submenu of the submenu depicted in FIG. 8;

FIG. 10 is a depiction of an intercom control submenu of the user interface of FIG. 6;

FIG. 11 is a depiction of a sun roof control submenu of the user interface of FIG. 6;

FIG. 12 is a depiction of a windows control submenu of the user interface of FIG. 6;

FIG. 13 is a depiction of a lighting control submenu of the user interface of FIG. 6;

FIG. 14 is a depiction of a door lock control submenu of the user interface of FIG. 6;

FIG. 15 is a depiction of a seat control submenu of the user interface of FIG. 6; and

FIG. 16 is a depiction of climate control submenu of the user interface of FIG. 6.

### DETAILED DESCRIPTION OF PREFERRED EMBODIMENTS

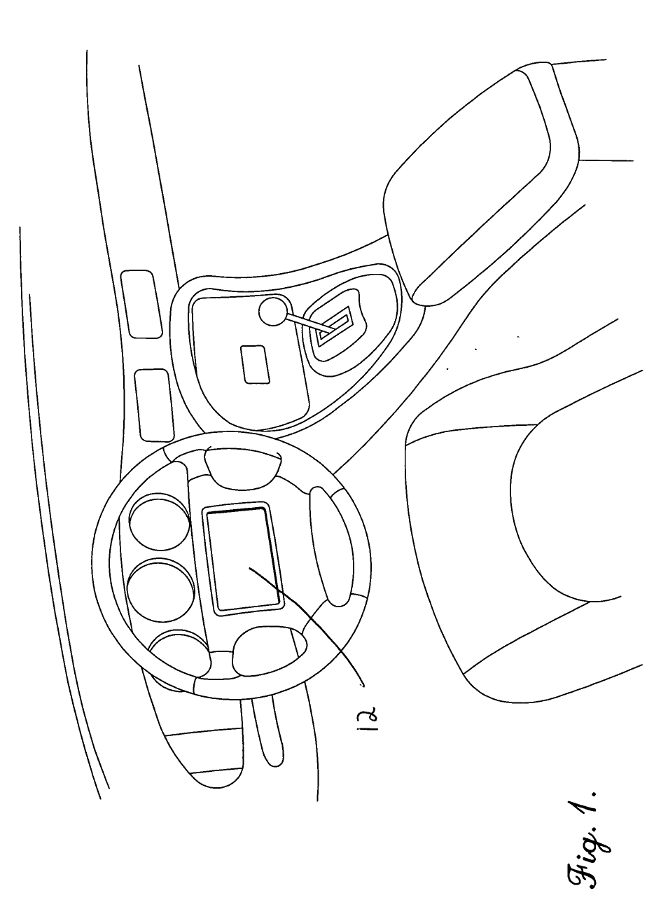

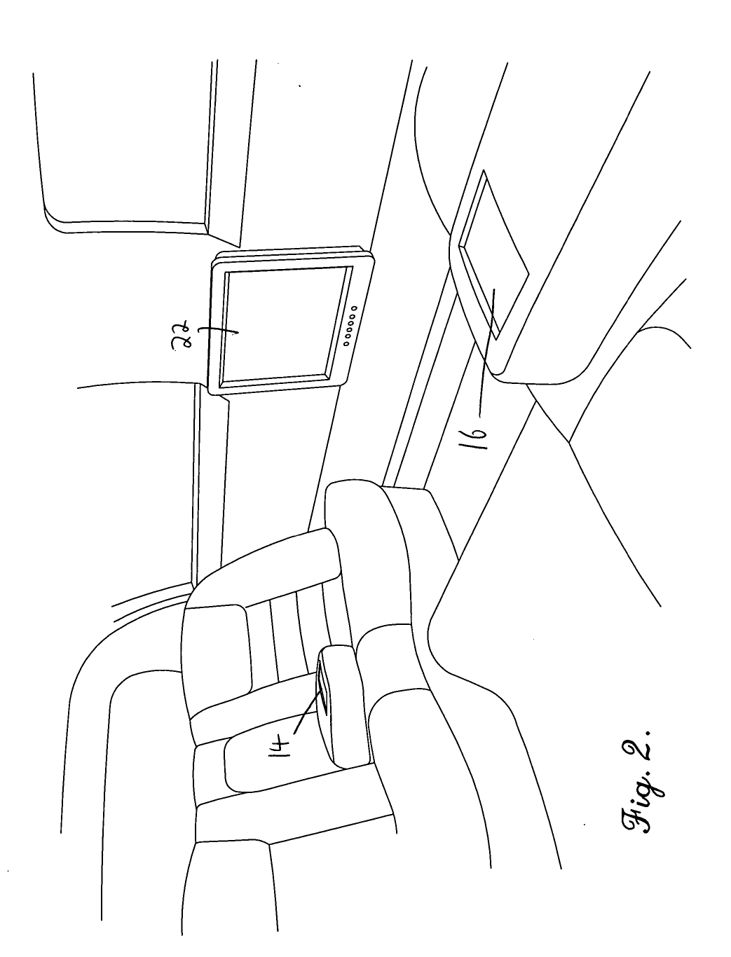

Turning to FIGS. 1-2, a vehicle entertainment and accessory control system is shown constructed in accordance with a preferred embodiment of the present invention. The system generally provides users with centralized, user-friendly control of various entertainment components and other accessories of the vehicle. Referring also to FIG. 3, the illustrated vehicle entertainment and accessory control system 10 includes a master touchscreen 12; a plurality of passenger touchscreens 14,16; a computer processor 18; an infrared controller 20; a video display 22; a speaker 24; a media source 26; an intercom 28; a plurality of audio jacks 30,32 and a plurality of accessory controllers 34,36.

The master touchscreen generally presents a user interface and receives instructions from a user, wherein the instructions relate to control of the passenger touchscreens and system accessories pertinent to a driver or other user who manages or controls the system 10. The illustrated master touchscreen 12 provides a user with control over entertainment components, such as the video display 22 and the speaker 24; other vehicle accessories, such as the intercom 28; and the passenger touchscreens 14,16. The master touchscreen 12 is particularly suited to be used by a driver, such as a limousine chauffeur, but may also be used by another user to control the system 10 and to limit access to the system 10 via the passenger touchscreens 14,16. To be easily accessible by the driver the master touchscreen 12 is preferably located near the driver, such as in the steering wheel as illustrated in FIG. 1, in the dashboard, or near or adjacent to the driver's seat. The picture quality of the touchscreen 12 is sufficient to allow it to display various types of video, such as entertainment and instructional video, in addition to the user interface. Due to the limited space available in the vicinity of the driver, the master touchscreen is small and as such preferably includes a liquid crystal display but may include other display means, such as, for example, a plasma display or a traditional cathode ray tube. A preferred implementation of the master touchscreen is described below in greater detail.

The passenger touchscreens generally present a user interface and receive instructions from a user that relate to control of entertainment components and other system accessories pertinent to a passenger. The illustrated passenger touchscreens 14,16 are similar to the master touchscreen 12, but differ in that the passenger touchscreens 14,16 are distributed throughout the vehicle and positioned to be easily accessible by passengers generally. The passenger touchscreens 14,16 further differ from the master touchscreen 12 in that the passenger touchscreens 14,16 do not enable users to control access to the system 10 via other touchscreens. To facilitate passenger accessibility, the touchscreens 14,16 may be embedded in a console as illustrated in FIG. 2, embedded in the back of a seat, or embedded in a vehicle wall or ceiling. A preferred implementation of the passenger touchscreens 14,16 is described below in greater detail.

The computer processor generally controls the operation of the touchscreens, receives the instructions from the touchscreens, and generates entertainment and accessory control signals in response to the instructions. The illustrated computer processor 18 is in two-way communication with each of the touchscreens 12,14,16 to generate and control the user interfaces and to receive the control and entertainment instructions communicated to each touchscreen by a user. The processor 18 generates entertainment and accessory control signals in response to the instructions, wherein the control signals are communicated to and control the entertainment components, such as the infrared controller 20 and the video display 22, as well as other accessories, such as the intercom 28 and the accessory controllers 34,36. The processor 18 and any related circuitry are preferably embedded within the vehicle, such as in the dashboard, and is easily accessible to facilitate testing and replacement.

By way of example, when a user submits an instruction to the passenger touchscreen 14 to activate the intercom 28, the touchscreen 14 communicates that instruction to the processor 18, which generates an accessory control signal to activate the intercom 28. A user may also submit an instruction via the master touchscreen 12 to control the passenger touchscreens 14,16. Control instructions from the master touchscreen 12, for example, may direct the processor 18 to limit access to the system 10 via the passenger touchscreens 14,16.

As illustrated in FIG. 3, the processor 18 is capable of communicating with and controlling multiple touchscreens and accessories and therefore must have a commensurate amount of inputs and outputs and computing power. Alternatively, external circuitry, such as multiplexers (not shown) may be used to enable the processor to communicate with and control the various touchscreens and accessories. Yet another alternative is to use multiple processors to share the computing burden.

The infrared controller generally receives the entertainment control signals from the processor and generates infrared control signals in response to the entertainment control signals, wherein the infrared control signals wirelessly control entertainment components. The illustrated infrared controller 20 is embedded within the vehicle, such as within the walls or ceiling, to avoid obstructing use of the vehicle and to remain hidden. The infrared controller 20 generates wireless infrared signals that control the video display 22, the speaker 24, and the media source 26. The infrared signals generated by the controller 20 are substantially universally detectable by remotely controlled displays, DVD players, radios and other entertainment system components. The infrared controller 20 thus operates in much the same way as a universal remote control known in the art. It will be appreciated that universal nature of the infrared signals makes repairing and upgrading the entertainment components relatively fast and inexpensive. Components such as the video display 22, the speaker 24 and the media source 26, for example, may be easily replaced with off-the-shelf consumer products not specifically designed for use in the vehicle.

By way of example, a user submits an instruction to play or stop a DVD via a passenger touchscreen 14. The touchscreen 14 communicates the instruction to the processor 18, which generates an entertainment control signal received by the infrared controller 20. The infrared controller 20 generates an infrared control signal in response to the entertainment control signal, wherein the DVD player detects the infrared signal and plays or stops the DVD in response to the signal. If the DVD player needs to be replaced, another DVD player that detects universal remote signals can be quickly and easily purchased and installed.

The video display generally displays entertainment video in response to the infrared control signals generated by the infrared controller. The illustrated video display 22 is a flat-panel LCD mounted within the vehicle in view of all or most vehicle passengers, such as on a wall of the vehicle, as illustrated in FIG. 2, or adjacent to a ceiling. The video display 22 receives video signals from the media source and provides video for several or all passengers, allowing them to watch, for example, a movie or a news broadcast. Given the limited amount of space available in most vehicles, the video display 22 is preferably an LCD or other thinly-profiled display. It will be appreciated, though, that the video display may employ any of various display technologies, including a traditional cathode ray tube.

The speaker generally plays audio in response to the infrared control signals generated by the infrared controller. The illustrated speaker 24 is preferably part of an audio system that comprises several speakers placed throughout the vehicle to provide audio entertainment to several or all passengers. The speaker 24 compliments the video display 22 by producing audio to accompany movies and other video displayed on the video display 22. The speaker 24 is also used without the video display 22 to play, for example, music from a radio station or from a CD. The speaker 24 may also be used with the intercom 28 to eliminate the need for a dedicated intercom speaker. When used with the intercom 28, the speaker 24 enables the intercom 28 to be used as a public address system, wherein a user, such as a driver, makes an announcement or otherwise communicates with other users, such as passengers.

The media source generally communicates video and audio signals to the video display, the speaker and the audio jacks in response to the infrared control signals. The media source may also communicate video and audio signals to the master and passenger touchscreens directly or through the processor. The illustrated media source 26 preferably includes a DVD player; a videocassette player; a television receiver for receiving television signals from, for example, a satellite or a land-based broadcast station; a CD player; and a radio receiver for receiving radio signals from, for example, a satellite or a land-based broadcast station. The media source 26 channels video media, audio media, or both from any of these sources to the video display 22, the speaker 24, the touchscreens 12,14,16 and the audio jacks 30,32 in response to the infrared control signals generated by the infrared controller 20 and the entertainment control signals generated by the computer processor 18. The media source 26 may further include a computer hard drive and/or an electronic memory element, such as a Flash memory, to receive, store and communicate digital entertainment media.

The media source 26 enables each user to choose localized entertainment by channeling different signals to several destinations simultaneously. For example, if a first passenger chooses to view a movie from a television station broadcast from a satellite, for example, and a second passenger chooses to view a movie stored on DVD, each passenger may view his or her respective movie on the nearest passenger touchscreen 14,16. Alternatively, multiple passengers may view the broadcast movie on the video display 22 and the speaker 24 while a single passenger views the DVD movie on a touchscreen 14,16 and listens via earphones connected to an audio jack 30,32. Thus the system 10 is operable to provide entertain to all of the passengers generally via the video display 22 and the speaker 24, to individual passengers via the passenger touchscreens 14,16 and the audio jacks 30,32.

The media source 26 is preferably located out of sight in the vehicle, such as beneath a seat or embedded in a wall or floor. Alternatively, the media source 26 may be accessible by vehicle passengers and/or driver to facilitate changing media, such as CDs and DVDs. The media source may also be distributed throughout the vehicle, such as where a CD player is located at a first location within the vehicle and a DVD player is located at a second location within the vehicle.

It will be appreciated that the media source is not limited to the various media players and receivers discussed herein, but may include any number and variety of electronic sources of video and audio media. Furthermore, the media source may be built to facilitate interchanging and adding sources after the media source has been installed in the vehicle. By way of example, the media source may include a gaming system to allow users to play video games, and my further include media input ports to allow users to connect external electronic devices to the system 10.

The intercom generally provides a channel of communication between two users in response to the accessory control signals from the computer processor. The illustrated intercom 28 provides a channel of communication between a limousine chauffeur or other vehicle driver and one or more passengers and includes, therefore, a microphone and a speaker to encode and decode verbal communications, respectively. Intercom components, such as the intercom speaker and microphone, may be embedded in an arm rest or console of a passenger seat. Use of the intercom 28 is particularly necessary where the driver and passengers are isolated, which is common in limousines. The driver may initiate intercom communications via the master touchscreen 12, and a passenger may initiate intercom communications via a passenger touchscreen 14,16. To initiate intercom communication the driver, for example, “calls” the passenger by selecting a “call” option on an intercom menu displayed on the master touchscreen 12, described below in greater detail. The intercom 28 alerts the passenger of the call, who then opens the communication via an intercom submenu on a passenger touchscreen 14,16.

In addition to passenger/driver communication, the intercom 28 further allows passengers to communicate with each other, which is particularly useful in a vehicle with many passengers, such as an airplane or a bus. The intercom 28 may further be used with the audio jacks 30,32, which are described in greater detail below, to maintain privacy. The intercom 28 may alert the passenger or driver of a call in any number of ways, and further may employ other portions of the system 10 to alert the passenger. The intercom 28 may sound an audible alert via an intercom speaker, for example, or may communicate the audible alert to the speaker 24. The intercom 28 may further present a visual intercom alert via the video display 22 or a passenger touchscreen 14,16.

The audio jacks generally provide audio outlets corresponding to each touchscreen and communicate audio signals in response to the entertainment control signals. The illustrated audio jacks 30,32 are electrical receptacles adapted to receive ear-phone plugs. A user may connect a set of earphones to an audio jack 30,32, for example, to hear audio corresponding to a movie that is displayed on the video display 22 or on a passenger touchscreen 14,16. This is particularly useful where a user desires to view media other than that which is displayed on the video display 22 by watching a movie on a passenger touchscreen 14,16 and receiving the audio corresponding to the movie via an audio jack 30,32. Furthermore and as mentioned above, the audio jacks 30,32 may be used with the intercom 28 to communicate messages to a single user or a group of users in privacy. Each audio jack 30,32 corresponds to, and is placed near, a passenger touchscreen 14,16.

The system 10 further includes a plurality of accessory controllers that control vehicle accessories other than those described above. The accessory controllers generally provide an interface between the processor 18 and various vehicle accessories, such as power windows and power door locks. The illustrated accessory controllers 34,36 may include an electric motor, an electronic relay or switch, a microcontroller or other controllers or actuators that control, for example, a climate control system, a light, a sun roof, a power window, a power door lock or a power seat. It will be appreciated that the accessory controllers 34,36 described herein are only exemplary and that any number and type of such controllers may be included in the system 10.

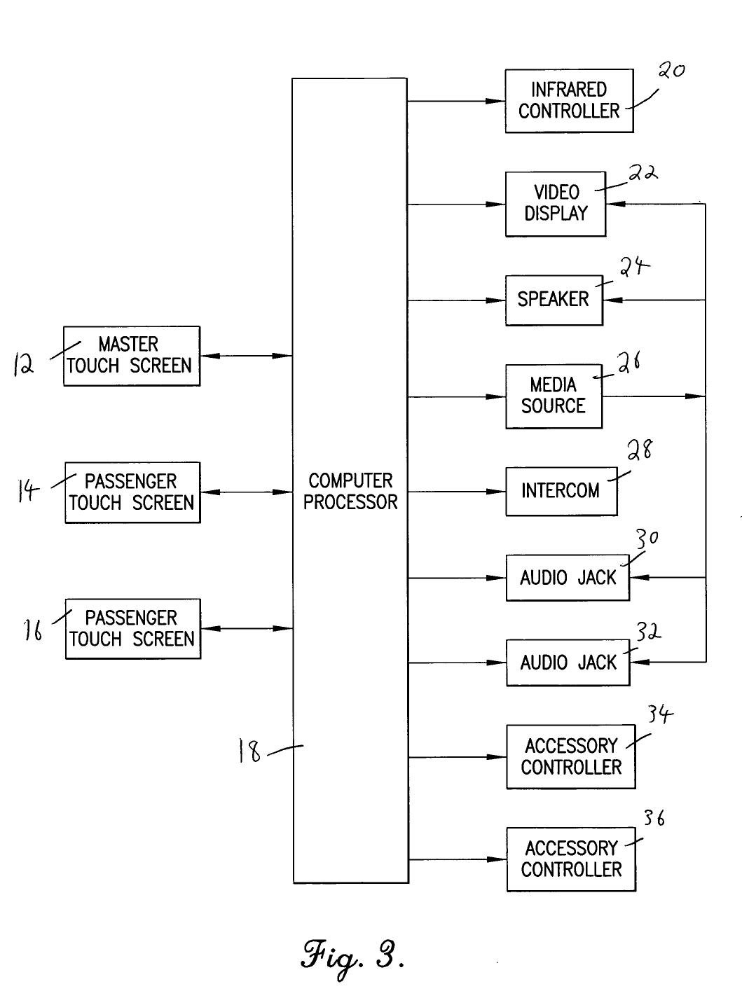

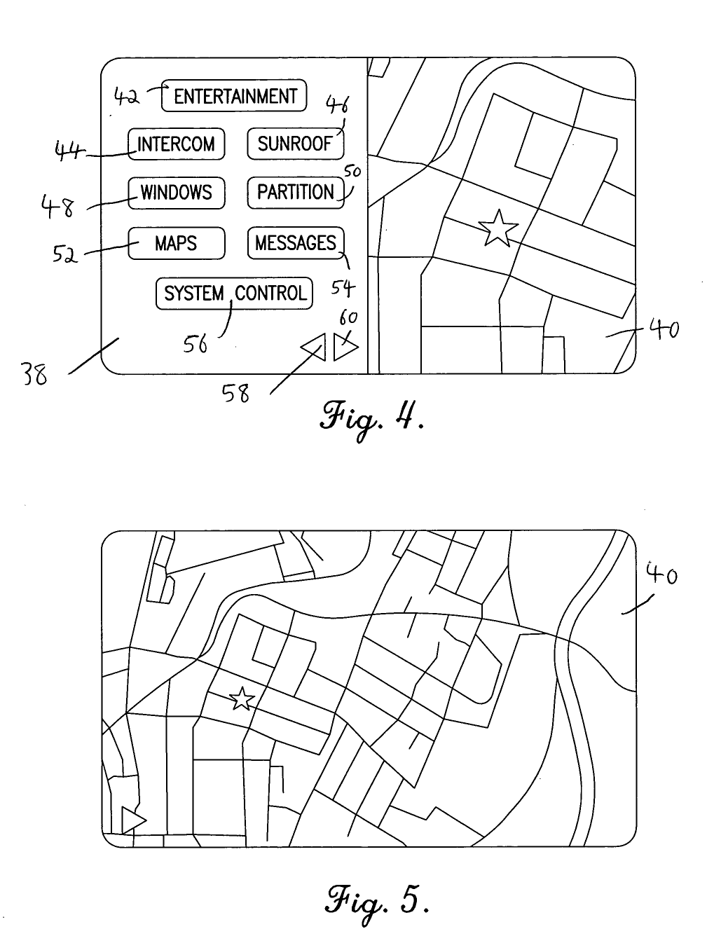

In a preferred implementation, the master touchscreen 12 displays a graphical user interface 38 concurrently with a video window 40, as illustrated in FIG. 4. Thus, the master touchscreen 12 is preferably used in a “split screen” format, with the interface 38 occupying a first portion of the touchscreen 12 and the video window 40 occupying a second portion of the touchscreen 12. While the illustrated interface 38 and the video window 40 are roughly of equal size and are positioned side-by-side, it will be appreciated that the present invention contemplates concurrently displaying the interface and the video window in various ways. The interface may be much smaller than illustrated in FIG. 4, for example, and may be inset within the video window while the video window occupies all, or nearly all, of the touchscreen 12.

The interface 38 presents the driver with a menu of control options as illustrated in FIG. 4. The driver selects an option by touching the touchscreen 12 where the option is displayed. When an option is selected, the Interface 38 may present a list of controls, a submenu, or both, depending on the particular menu item selected. This functionality is described in greater detail below in relation to the passenger touchscreens 14,16.

In the illustrated interface 38 of FIG. 4, the control options are identified by control option icons, including an entertainment icon 42; an intercom icon 44; a sun roof icon 46; a windows icon 48; a partition icon 50; a maps icon 52; a messages icon 54; and a system control icon 56. Selecting the entertainment control option 42 provides access to controls that relate to, for example, the infrared controller 20 and the video window 40 of the master touchscreen 12. The entertainment controls allow the driver to select a video source, such as a DVD or television station, to play on the video display 22, the video window 40 of the master touchscreen 12, or both. Using the entertainment control option 42 the driver can select a video presentation for other passengers of the vehicle and/or for himself or herself. The driver may choose to select a video presentation for other passengers of the vehicle where, for example, the other passengers are not familiar with the system 10 or the driver desires to limit what the other passengers view, such as where the driver is a parent choosing a video presentation for a child.

The intercom control option 44 allows the driver to initiate communications with one or more passengers via the intercom 28. Such a feature is particularly useful, for example, in a limousine where the chauffeur is isolated from the passengers. The sun roof control option 46 presents controls that open and close one or more sun roofs in the ceiling of the vehicle. The windows control option 48 presents controls that allow the driver to open or close one or more windows in the vehicle. This may be especially useful in a limousine or other vehicle wherein the driver needs to control several windows, some of which are not visible to the driver. After passengers have left the vehicle, for example, a driver may ascertain which windows are down by viewing a status indicator of a submenu (not shown) of the intercom control option 48 and close those windows that are indicated as open. The window controls may also include a control that opens or closes all windows, wherein the system 10 detects which windows are open and which are closed.

The partition control option 50 presents controls relating to a partition that separates, for example, the driver of a limousine from the passengers. Such controls open and close the partition, for example. The maps control option 52 presents controls relating to viewing and navigating maps, such as the map illustrated in FIGS. 4-5. A vehicle driver may need to use maps, for example, to navigate in an unfamiliar local. The maps may be stored in a computer memory (not shown) of the system 10 or may be downloaded from the Internet via a communications interface (not shown). The driver or other user may use map controls to display a pre-loaded map, and to zoom and scroll the image of the map.

The messages icon 54 allows the driver to receive textual messages from and send such messages to other users of the system 10 or a remote base station. Using message controls, the driver could communicate a textual message via the video display 22 or the passenger touchscreens 14,16, to passengers informing them, for example, of time remaining in a trip. Such a textual message would create only a minimal distraction and thus may be preferable to a communication via the intercom 28. The system control option 56 presents controls relating to the configuration of the system 10. Using system controls, for example, the driver may disable the passenger touchscreens 14,16 or may enable and disable the driver safety feature described above.

The master touchscreen 12 includes screen control icons 58,60 that enable a user to configure the touchscreen 12. As illustrated in FIG. 4, the master touchscreen 12 concurrently displays both the interface 38 and the video window 40. The screen control icons 58,60 enable a user to expand the video window 40 to fill the entire screen by pressing screen control icon 58, orto expand the Interface 38 to fill the entire screen by pressing screen control icon 60. A driver may choose to view a map in the video window 40, for example, using controls under the maps control option 52. Fora larger image of the map the driver may press screen control icon 58 to cause the video window 40 to expand to fill the entire touchscreen 12, as illustrated in FIG. 5. A screen control icon 60 remains visible in the expanded video window so that the driver may quickly restore the split screen illustrated in FIG. 4. Alternatively, the icon 60 may not be visible in the expanded video window, wherein the split screen is restored when the driver touches any portion of the touchscreen.

The video window 40 displays entertainment video or other video that may be of interest or use to a driver or other user. As illustrated in FIG. 4, the video window 40 may display a street map to assist the driver in navigating. Alternatively, the driver may choose to view a movie or television show in the video window 40.

The system 10 implements a driver safety feature wherein the video window 40 of the master touchscreen 12 automatically stops displaying entertainment video when other tasks command the driver's attention, such as when the car is in motion and the task of driving commands the driver's attention. Such functionality is essentially a safety feature intended to prevent accidents or mishaps resulting from the diversion of the driver's attention. Such a feature may not be implemented, or may be selectively disabled, where the master touchscreen 12 is not used by a driver, such as where a first spouse is driving a vehicle and a second spouse desires to control and view the entertainment displayed for children.

It will be appreciated that the master touchscreen may present any number of controls of various types to a driver or other user, and is not limited to the controls and options specifically discussed herein with respect to the illustrated master touchscreen 12.

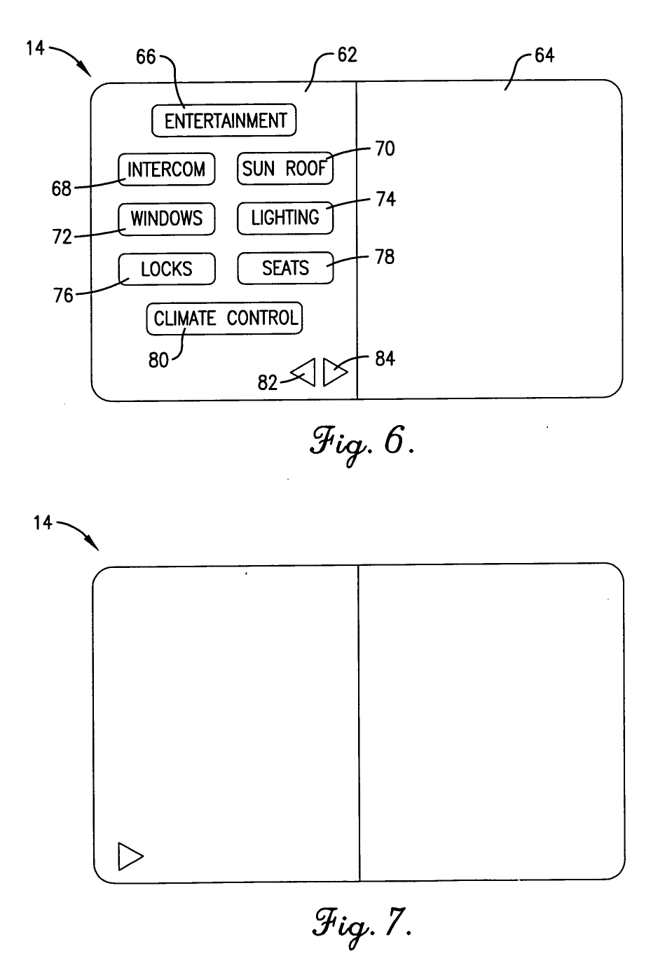

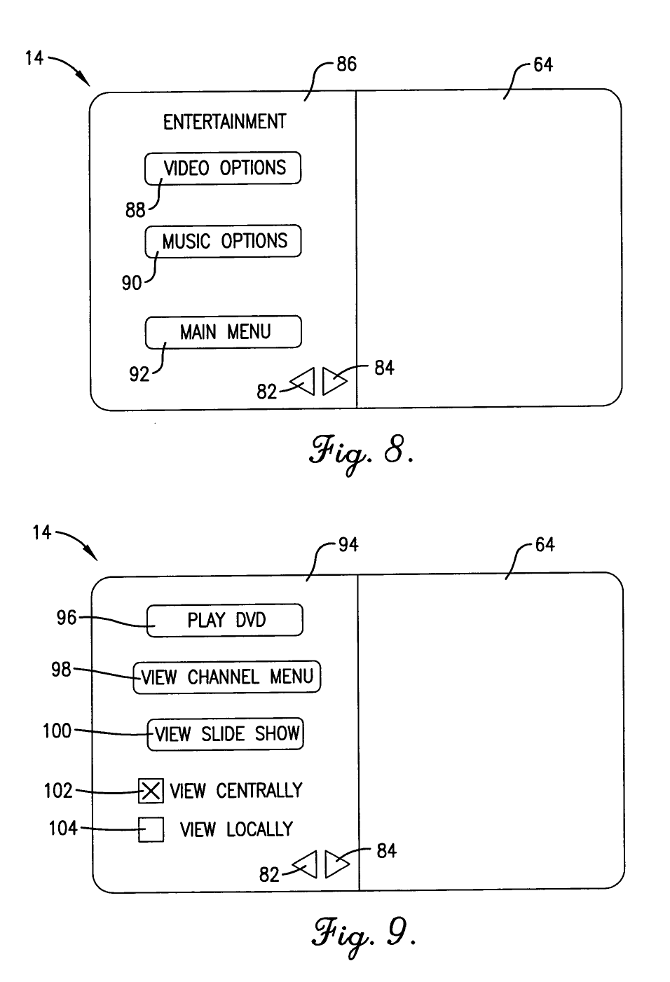

Passenger touchscreens 14,16 are substantially identical in operation and therefore only the implementation of touchscreen 14 will be described in detail, with the understanding that touchscreen 16 is implemented in a substantially identical manner. In the preferred implementation, the passenger touchscreen 14 displays a graphical user interface 62 concurrently with a video window 64 as illustrated in FIG. 6. The interface 62 and the video window 64 may be of various sizes, and may be resized as described above in relation to the master touch screen 12.

The interface 62 presents a passenger with various control options. The interface 62 first presents a menu of options, wherein each option is represented by an icon. The passenger selects an option by touching a corresponding icon. When an option is selected, the interface 62 may present a list of controls, a submenu, or both, depending on the particular menu item selected. In the illustrated interface 62, the control option icons include entertainment 66; intercom 68; sun roof 70; windows 72; lighting 74; locks 76; seats 78; and climate control 80 icons.

Screen control icons 82,84 function similar to the screen control icons 58,60 described above in relation to the master touchscreen 12, and allow a user to expand either the interface 62 or the video window 64 to occupy the entire touchscreen 14. FIG. 7 illustrates the touchscreen 14 wherein a user has expanded the video window 64 to occupy the entire touchscreen 14 by touching screen control icon 82.

Selecting the entertainment icon 66 causes the interface 62 to display an entertainment submenu 86, wherein the submenu 86 presents a video options icon 88 and a music options icon 90. FIG. 9 illustrates an exemplary video options submenu 94 displayed by the touchscreen 14 when a user selects the video options icon 88. The video options submenu 94 allows a user to choose what he or she will view as well as where to view it. A play DVD icon 96, for example, allows the passenger to play a DVD, a view channel menu icon 98 allows the passenger to choose a particular television channel to view, and a view slide show icon 100 allows the passenger to view a slide show of digital images taken by the passenger.

Choosing the play DVD icon 96 causes the touchscreen 14 to display more detailed DVD options, such as a choice of DVDs and a virtual DVD control panel with traditional DVD controls. Choosing the view channel menu icon 98 causes the touchscreen 14 to display a menu of television channels, such as cable or satellite channels. Choosing the view slide show icon 100 causes the touchscreen 14 to present a slide show of digital images.

The video options submenu further allows the passenger to choose where to view the video via the check boxes 102,104. If the “view centrally” check box 102 is chosen, for example, the video will be displayed on the video display 22. If the “view locally” check box 104 is chosen the video will be displayed on the video window 64 of the touchscreen 14. Allowing the passenger to choose where to view the video is useful, for example, where a passenger wishes to view video other than that which is being displayed on the video display 22. In that case the passenger may choose a video to watch locally on the touchscreen 14, plug a pair of earphones into an audio jack 30,32 that corresponds to the touchscreen 14, and watch the video on the touchscreen 14 and listen to the corresponding audio on the headphones.

Choosing the music options icon 90 similarly causes the touchscreen 14 to display a submenu or control panel (not shown) that allows the passenger to choose audio, such as a song or a radio station, to listen to. The passenger would be able to choose to play the audio centrally over the speaker 24 or locally via an audio jack 30,32.

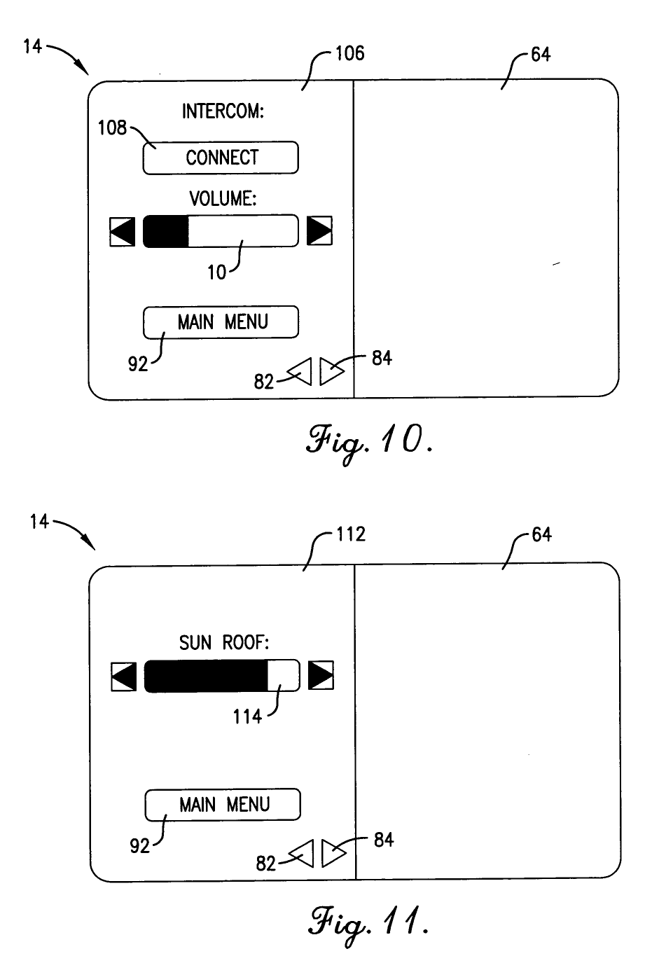

Choosing the intercom control icon 68 of the interface 62 causes the touchscreen 14 to present the passenger with controls that relate to the intercom 28. An exemplary intercom control panel 106 is illustrated in FIG. 10. The control panel 106 includes a connect icon 108 as well as a volume control icon 110. Choosing the connect icon 108 causes the touchscreen 14 to communicate a connect control signal to the computer processor 18, which causes the processor 18 to connect the intercom 28 between the passenger and the driver. Alternatively, the connect icon 108 may cause the touchscreen 14 to display a menu of users from which the passenger chooses with whom to connect. The volume control icon 110 allows the passenger to adjust the loudness of a speaker (not shown) that is part of the intercom 28. The intercom submenu 106 further presents the main menu icon 92, which causes the touchscreen 14 to present the interface 62 if chosen.

Choosing the sun roof control icon 70 of the interface 62 causes the touchscreen 14 to display controls that relate to the a sun roof. An exemplary sun roof control panel 112 is illustrated in FIG. 10. The sun roof control panel 112 includes a sun roof open and close control icon 114, wherein the icon 114 presents to the passenger a graphical representation of the state of the sun roof as well as controls to open and close the sun roof.

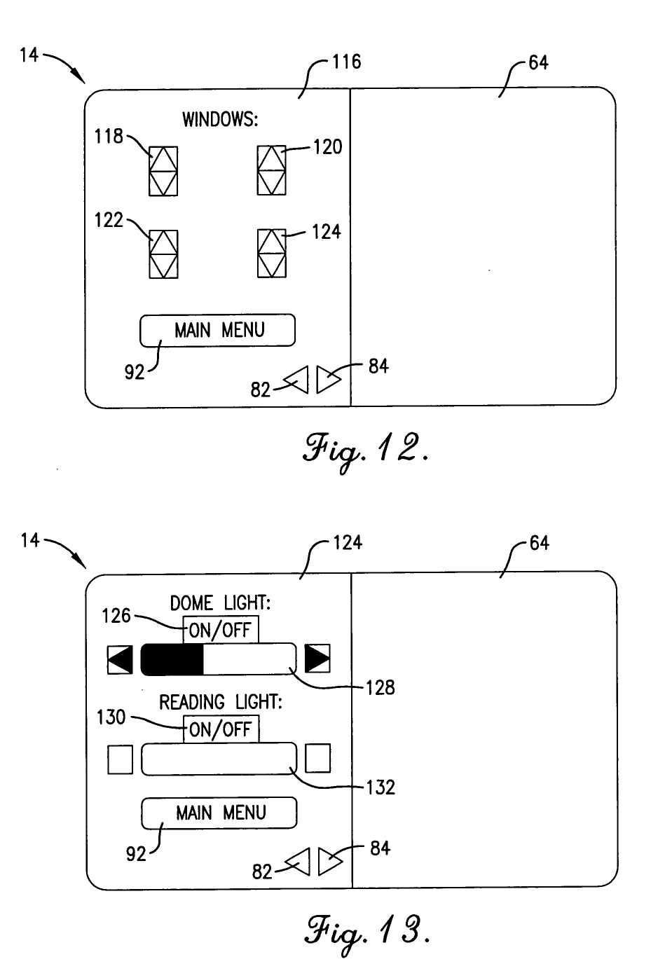

Choosing the windows control icon 72 of the interface 62 causes the touchscreen 14 to display controls for opening and closing vehicle windows. An exemplary window control panel 116 is illustrated in FIG. 12. The window control panel 116 includes window open and close control icons 118,120,122,124. Each icon 118,120,122,124 corresponds to a window and serves as a virtual controller, opening or closing the window.

Choosing the lighting control icon 74 of the interface 62 causes the touchscreen 14 to display controls for controlling interior vehicle lights. An exemplary lighting control panel 124 is illustrated in FIG. 13. The lighting control panel includes a dome light on/off control 126; a dome light intensity adjustment control 128; a reading light on/off control 130; and a reading light intensity adjustment control 132. The dome light on/off control 126 turns a vehicle dome light on and off, wherein the dome light illuminates a large area of the interior of the vehicle, and the dome light intensity adjustment control 128 adjusts the brightness of the dome light. The reading light on/off control 130 turns a passenger reading light on and off, wherein the reading light illuminates a smaller area of the interior of the vehicle than the dome light. The reading light intensity adjustment control 132 adjusts the brightness of the reading light. When the dome light and the reading light are off, the intensity adjustment controls 128,132 are inactive, as illustrated by the reading light intensity adjustment control 132 in FIG. 13.

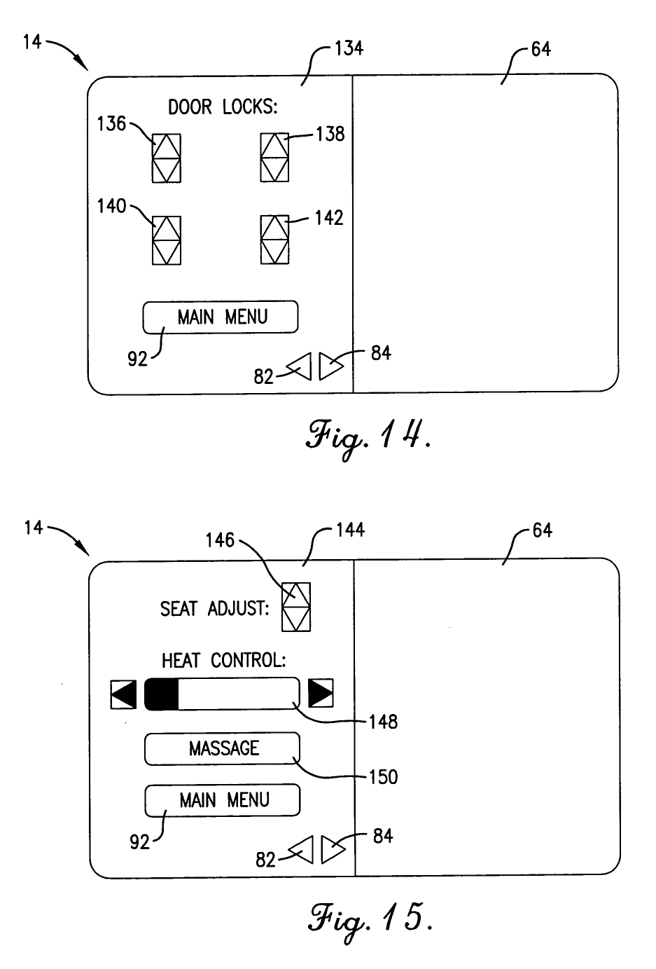

Choosing the lock control icon 76 of the interface 62 causes the touchscreen 14 to display controls for controlling vehicle locks, such as door locks. An exemplary lock control panel 134 is illustrated in FIG. 14. The locks control panel 134 is similar to the windows control panel 116 and includes door lock and unlock control icons 136,138,140,142. Each icon 136,138,140,142 corresponds to a door and serves as a virtual controller, locking and unlocking the door. The lock control panel may lock and unlock a vehicle trunk, hood or hatch and thus is not restricted to use with door locks. In some implementations there may be fewer than four locks, such as a passenger touchscreen in a limousine wherein there is only one door to the passenger compartment. Other implementations may include more than four locks, such as a master touchscreen in a family van wherein the lock control panel includes four locks corresponding to vehicle doors and one lock corresponding to a hatch or rear door.

Choosing the seat control icon 78 of the interface 62 causes the touchscreen 14 to display controls for controlling vehicle seats. An exemplary seat control panel 144 is illustrated in FIG. 15. The seat control panel 144 includes a seat adjust icon 146 for moving a seat forward or backward; a heat control icon 148 for increasing or decreasing the degree to which a seat is heated; and a massage control icon 150 to start and stop a massager within a seat and choose a type of massage to administer.

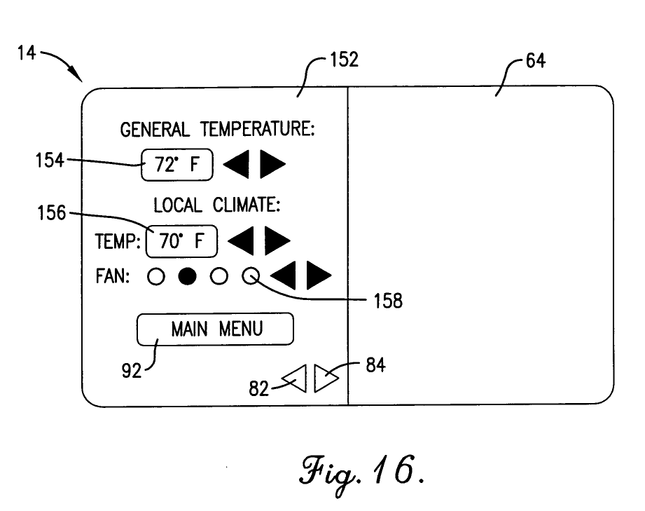

Choosing the climate control icon 78 of the interface 62 causes the touchscreen 14 to display controls for controlling vehicle climate. An exemplary climate control panel 152 is illustrated in FIG. 16. The climate control panel 152 includes a general temperature control icon 154; a local temperature control icon 156; and a local fan control icon 158. The general temperature control icon 154 controls the general temperature of the interior of the vehicle by setting a thermostat to a temperature chosen by a user. Individual passengers may choose climate settings unique to their location in the car via the local temperature control icon 156 and the local fan control icon 158.

Although the invention has been described with reference to the preferred embodiments illustrated in the attached drawings, it is noted that equivalents may be employed and substitutions made herein without departing from the scope of the invention as recited in the claims. It will be appreciated, for example, that in place of the infrared controller 20 the system 10 may include a wired controller that connects to the video display, the speaker and the media source via wired connections.

Having thus described the preferred embodiment of the invention,

1. A vehicle entertainment and accessory control system, the system comprising:
a touchscreen for concurrently displaying a user interface and entertainment video and for receiving entertainment and accessory control instructions via the interface;
a computer processor for controlling the touchscreen, receiving the instructions from the touchscreen, and generating entertainment and accessory control signals in response to the instructions;
an infrared controller for generating infrared control signals in response to the entertainment control signals; and
an intercom for providing communication between two users in response to the accessory control signals.

2. The system as set forth in claim 1, wherein the touchscreen displays the entertainment video in response to the entertainment instructions.

3. The system as set forth in claim 2, wherein the touchscreen selectively displays only the user interface, only the entertainment video, or the user interface and the entertainment video concurrently.

4. The system as set forth in claim 1, further comprising a plurality of touchscreens distributed throughout the vehicle and accessible by a plurality of users.

5. The system as set forth in claim 4, wherein each touchscreen further receives a textual message from a user and the message is communicated to another user via a touchscreen or the video display.

6. The system as set forth in claim 4, wherein access to one or more of the touchscreens is selectively disabled.

7. The system as set forth in claim 6, wherein access to one or more of the touchscreens is selectively disabled via a master touchscreen.

8. The system as set forth in claim 6, wherein the processor prevents entertainment video from being displayed on a driver's touchscreen while the vehicle is moving.

9. The system as set forth in claim 1, further comprising a video display for displaying entertainment video in response to the infrared control signals.

10. The system as set forth in claim 9, further comprising a speaker for playing audio in response to the infrared control signals.

11. The system as set forth in claim 10, further comprising a media source for communicating video and audio signals to the video display and to the speaker in response to the infrared control signals.

12. The system as set forth in claim 11, wherein the media source is chosen from the group consisting of a computer hard drive, an electronic memory element, a DVD player, a CD player, a videocassette player, a television receiver, and a radio receiver.

13. The system as set forth in claim 1, further comprising an accessory controller for selectively controlling a vehicle accessory in response to the accessory control signals generated by the processor.

14. The system as set forth in claim 13, wherein the accessory controller controls an accessory chosen from the group consisting of a climate control system, a light, a sun roof, a power window, a power door lock, and a power seat.

15. The system as set forth in claim 1, wherein the intercom selectively provides communication between a driver and a passenger in response to the accessory control signals generated by the processor.

16. The system as set forth in claim 1, further comprising an audio jack corresponding to the touchscreen for communicating an audio signal in response to the entertainment control signals.

17. A vehicle entertainment and accessory control system, the system comprising:
a plurality of touchscreens distributed throughout a vehicle and accessible by a plurality of users, wherein each touchscreen selectively displays only a user interface, only entertainment video, or both the user interface and the entertainment video concurrently, and wherein the touchscreen receives entertainment and accessory control instructions via the interface;
a computer processor for controlling the touchscreens, receiving the instructions from the touchscreens, and generating entertainment and accessory control signals in response to the instructions;
an infrared controller for generating infrared control signals in response to the entertainment control signals;
an intercom for selectively providing communication between two users in response to the accessory control signals; and
an accessory controller for selectively controlling a vehicle accessory in response to the accessory control signals.

18. The system as set forth in claim 17, wherein each touchscreen displays the entertainment video in response to the entertainment instructions.

19. The system as set forth in claim 17, wherein access to one or more of the touchscreens is selectively disabled via a master touchscreen.

20. The system as set forth in claim 17, wherein the processor prevents entertainment video from being displayed on a driver's touchscreen while the vehicle is moving.

21. The system as set forth in claim 17, further comprising a video display for displaying video in response to the infrared control signals.

22. The system as set forth in claim 21, further comprising a speaker for playing audio in response to the infrared control signals.

23. The system as set forth in claim 22, further comprising a media source for communicating video and audio signals to the video display and to the speaker system in response to the infrared control signals.

24. The system as set forth in claim 23, wherein the media source is chosen from the group consisting of computer hard drive, an electronic memory element, a DVD player, a CD player, a videocassette player, a television receiver, and a radio receiver.

25. The system as set forth in claim 17, wherein the accessory controller controls an accessory chosen from the group consisting of a climate control system, a light, a sun roof, a power window, a power door lock, and a power seat.

26. The system as set forth in claim 17, further comprising a plurality of audio jacks, wherein each audio jack corresponds to a touchscreen and communicates an audio signal in response to the entertainment control signals.

27. The system as set forth in claim 17, wherein each touchscreen further receives a textual message from a user and the message is communicated to another user via a touchscreen or the video display.

28. A vehicle entertainment and accessory control system, the system comprising:
a plurality of touchscreens distributed throughout a vehicle and accessible by a plurality of users, wherein each touchscreen displays a user interface and receives entertainment and accessory control instructions from a user via the interface, each touchscreen selectively displays entertainment video in response to the entertainment control instructions, and each touchscreen selectively displays only the interface, only the video, or both the interface and the video concurrently, wherein access to one or more of the touchscreens is selectively disabled via a driver's touchscreen and display of entertainment video on a driver's touchscreen is disabled while the vehicle is moving;
a computer processor for controlling the touchscreens, receiving the instructions from the touchscreens, and generating entertainment and accessory control signals in response to the instructions;
an infrared controller for generating infrared control signals in response to the entertainment control signals;
a video display for displaying entertainment video in response to the infrared control signals;
a speaker for playing audio in response to the infrared control signals;
a media source for communicating video and audio signals to the video display and to the speaker in response to the infrared control signals;
an intercom for providing communication between a driver and a passenger in response to the accessory control signals generated by the processor; and
a plurality of accessory controllers for controlling vehicle accessories in response to the accessory control signals generated by the processor.

29. The system as set forth in claim 28, wherein the video source is chosen from the group consisting of a computer hard drive, an electronic memory element, a DVD player, a CD player, a videocassette player, and a television receiver.

30. The system as set forth in claim 28, wherein the accessory controllers control accessories chosen from the group consisting of a climate control system, a light, a sun roof, a power window, a power door lock, and a power seat.

31. The system as set forth in claim 28, further comprising a plurality of audio jacks, wherein each audio jack corresponds to a touchscreen and communicates an audio signal in response to the entertainment control signals.

32. The system as set forth in claim 28, wherein each touchscreen further receives a textual message from a user, communicates the message to the processor, the processor communicates the message to a second touchscreen, and the second touchscreen displays the message.

33. The system as set forth in claim 32, wherein the processor communicates the message to the media source, and the media source communicates the message to the video display.
